(19) United States
(12) Patent Application Publication
(10) Pub. No.: US 2003/0086825 A1
(43) Pub. Date: May 8, 2003

(54) Nose airway device for detecting airborne contaminants

(76) Inventor: H. George Brennan, Newport Beach, CA (US)

Correspondence Address: Michael G. Petit, P.O. Box 91929, Santa Barbara, CA, 93190-1929, US

(21) Appl. No.: 10/008,870

(22) Filed: Nov. 2, 2001

(51) Int. Cl. G01N 31/22

(52) U.S. Cl. 422/83; 422/86; 422/88; 436/181; 600/529; 600/532; 606/199; 73/31.02; 73/31.03

(57) ABSTRACT

An airborne contaminant indicating device adapted for attachment to a person's nose for indicating the presence of a contaminant entrained in an air stream passing through the nose. In a particularly preferred embodiment, the device is a clip with a proximal “UU” shaped dilating portion adapted to be inserted within the nostrils; the “U's” being connected to one another medially by an elastically deformable extension portion, the extension portion being two straight parallel strips, one end of the strips being integral with the dilating portion and the opposing end of the strip integral with an arcuate septum attachment portion. The septum attachment portion spaces the distal ends of the strips of the extension portion so that the strips straddle and gently squeeze the nasal septum. The device has a contaminant-interactive coated surface in contact with a portion of the air passing through the nose. The design of the embodiment provides maximum air flow through the nostrils. The proximal, dilating portion of the device consists of two “U” shaped strips, each strip being affixed to a proximal open end of the “U” shaped extension portion and at right angles to the plane of the extension portion. The dilating portion presents a smooth outer tissue-contacting surface which urges against the inner surface of the walls of the nostrils forcing them outwardly. A portion of the surface in opposition to the tissue-contacting surface includes a contaminant interactive coating that is adapted to provide an indication of one or more contaminants in the air.

### BACKGROUND OF THE INVENTION

1. Field of the Invention

This invention relates to a device adapted for temporary insertion within the nose for establishing and/or maintaining an airway through the nasal passages and for detecting the presence of noxious airborne substances.

2. Description of the Prior Art

Various forms of nasal airway devices are known in the art. Examples of such devices are disclosed in the following U.S. Pat. Nos. 851,048; 513,458, 4,414,977; 4,201,207; 2,515,756; 1,255,578; 1,481,581; 1,597,331; 1,672,591; 1,709,740; 1,135,675; 1,014,076; 1,014,758; 1,077,574 and British Patent GB0768488; British Patent 4,148; Italian Patent IT0490828 and French Patent 7807130. While most of these devices provide a means for dilating the nostrils and maintaining an airway permitting improved air flow therethrough, each has limitations producing less than optimum air flow or discomfort which prevents the device from being used for a prolonged period of time. Many devices are unsatisfactory due to non-unitary construction which can result in situ disintegration of the device and possible aspiration of a fragment of the device. The above devices do not have or teach the structural and functional features of the present invention described below which, in combination, enable the device to perform the intended function in a manner which is superior to the prior art devices. In particular, none of the prior art nasal airway devices include means operable for indicating the presence of an airborne contaminant entering the nasal passages.

The potential for human exposure to dangerous concentrations of noxious airborne contaminants such as anthrax spores has increased dramatically in recent months due to the introduction of pathogenic organisms into the work environment by deliberate criminal intent. Exposure to airborne contaminants such as anthrax spores and sarin gas is highly probable in the future, particularly for members of the military engaged in hostile action. In the case of anthrax, it is imperative that detection means operable for early detection of such human exposure to the airborne pathogen be available to both civilian and military populations. Ideally, such a detection system provides an indication and measure of an individual's exposure to a particular contaminant so that only individuals who have received a dangerously high level of exposure receive preemptive treatment. Accordingly, a detection device adapted to be worn upon the body and disposed to sample air that is actually inhaled by an individual is particularly desirable.

### SUMMARY OF THE INVENTION

It is a primary object of this invention to provide an intranasal device for sampling air delivered to the respiration passages and providing an indication of exposure to dangerous levels of contaminants in the air.

It is a further object of this invention to provide a device meeting the above objective and adapted to be comfortably attached to a person's nose, thereafter being operable for increasing the flow of air through the nasal passages during periods of physical activity requiring high oxygen demand or increased ventilation.

It is another object of this invention to provide a device meeting the above objectives and which includes a means for controlling and/or limiting the projection of the device into the nostrils while preventing the device from dislodging and being ejected from the nostril.

It is another object of this invention to provide a device which meets the objectives stated above and which can be easily and inexpensively manufactured by injection molding from an inexpensive hypoallergenic plastic composite, copolymer or elastomer coated plastic in a variety of sizes.

The above objects and advantages of the present invention are accomplished by the present nasal airway airborne contaminant indicator device. In a particularly preferred embodiment of an airborne contaminant indicator device in accordance with the present invention, the proximal dilating portion of the device comprises two “U” shaped surfaces adapted to be inserted into the nostrils. The dilating portion of the device is inter-connected by means of a bridging “U” shaped extension portion. The extension portion is a generally “U” shaped having a semicylindrical wall with an inner circumferential surface which is contoured to anatomically and snugly conform to the inferior (most distal) margin of the nasal septum. Thus, overall the device is generally “U” shaped, more or less resembling a cotter pin when viewed in front elevation and “U=U” shaped when the proximal portion is viewed end on from the top. The bifurcated extension portion comprises two identical substantially planar parallel strips oriented with their flat surfaces in parallel planes and connected to one another by the semicylindrical distal septum attachment portion. The symmetrical dilating portion is contoured to anatomically conform to the respective contours of the anterior inner surface of the nostrils. Since inhaled air flowing through the nose contacts the inner surfaces of the “U's”, a contaminant-adsorbing coating, applied thereto, that is operable for removing at least a portion of the contaminants, including particulates, from the airflow, is employed to provide evidence of the wearer's exposure to selected airborne contaminants

The features of the invention believed to be novel are set forth with particularity in the appended claims. However, the invention itself, both as to organization and method of operation, together with further objects and advantages thereof may best be understood by reference to the following description of a preferred embodiment of the invention, taken in conjunction with the accompanying drawings in which:

### BRIEF DESCRIPTION OF THE DRAWINGS

FIG. 1 is a front elevational view of a particularly preferred embodiment of an airborne contaminant indicating device in accordance with the present invention.

FIG. 2 is a perspective view of the airborne contaminant indicating device shown in FIG. 1.

FIG. 3 is a side view of the airborne contaminant indicating device of FIG. 2 viewed in the direction of line 3-3′.

FIG. 4 is a perspective inferior view of the airborne contaminant indicating device in accordance with the present invention positioned within the nose of a person and illustrating the disposition of the contaminant-sensitive coating with respect to the nasal airway passages.

FIG. 5 is a schematic lateral view of the airborne contaminant indicating device positioned within the nose which has been partially cut-a-way for illustration.

FIG. 6 is a perspective view of an embodiment of the invention having gripping pins adapted for facilitating instrument assisted insertion of the airborne contaminant indicating device into the nose.

FIG. 7 shows the cooperative functional relationship between the insertion instrument and the airborne contaminant indicating device of FIG. 6 prior to insertion of the device into the nose.

FIG. 8 is an elevational view of the airborne contaminant indicating device of FIG. 6 looking upward into the nose with the device properly positioned for operation and illustrating the trapping of particulate contaminants in the air by a cilia-like coating on a portion of the device.

### DESCRIPTION OF THE PREFERRED EMBODIMENTS

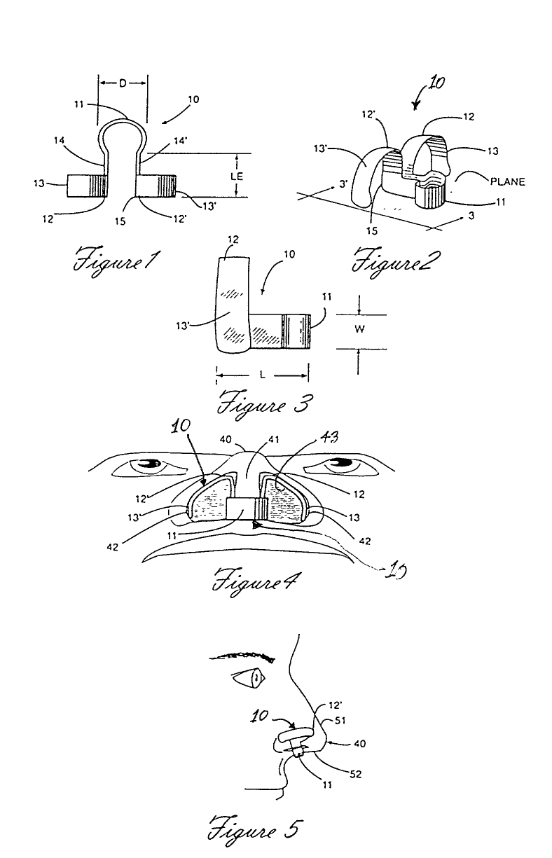

The airborne contaminant indicating device 10, shown in front (anterior) elevational view in FIG. 1, is a unitary strip of elastically deformable material, preferably hypoallergenic, elastomer shaped to form a symmetrical 3-dimensional structure as generally shown in FIG. 2. The airborne contaminant indicating device 10 is bifurcated and symmetrically disposed in structure with respect to the medial septum attachment portion 11. The septum attachment portion 11 is a semi-cylindrical arcuate distal coterminous for the inferior or distal end of the extension portion 14 and 14′ of the device 10, connecting the tines 14 and 14′ of the extension portion to one another and having an inner diameter D. The extension portion consists of tines 14 and 14′ and extends proximally, away from the septum attachment portion a distance L, the proximal terminus of the extension portions 14, 14′ being shown at 15. The dilating portion consists of two “U” shaped projections projecting anteriorly on a plane at right angles to the extension portion 14, to gracefully and arcuately curve laterally outward and posteriorly to form smooth, anatomically conforming tissue12 contacting surfaces 13 and 13′ which are mirror images of each other. The side of the dilating portions opposite the tissue contacting surfaces 13 and 13′ are coated with a material that interacts with airborne contaminants in such a way as to enable the device to be used for determining exposure to one or more airborne contaminants. The extension portion 14 and 14′ preferably be a length L between ½ inch and 1 inch. The width W of the device 10 is substantially uniform throughout the device and preferably in the range of ⅛-.5/16 inches. The thickness of the device, excluding the thickness of the contaminant adsorbing coating 43, is also substantially uniform throughout and preferably less than 1/16 of an inch.

The device may be positioned within the nose 40 (FIG. 4) by inserting the proximal end 15 of the airborne contaminant indicating device 10 into the nasal air passages 42 and advanced by applying pressure on the distal opposing end until the distal septum attachment portion 11 is in contact with the inferior margin of the nasal septum 41. At this point, the proximal end 15 of the device 10 can be advanced no further into the nasal passages 42 and the anatomically conforming tissue-contacting surfaces 13 and 13′ comprising the dilating portion press laterally against the anterior and lateral wall of the nasal passage to dilate the passage and maintain an airway therethrough. A contaminant interactive coating 43 disposed on the inner surface (i.e., the surfaces opposite the tissue-contacting surfaces 13 and 13′) of the dilating portion of the airborne contaminant indicating device 10 interacts with airborne contaminants in such a way as to provide an indication that a contaminant is, or was, present in the airflow stream during periods of use. A coating 43 may, for example, have numerous cilia-like filaments extending into the airstream. Such a filamentous coating 43 extracts particulates (not shown in FIG. 4) from the airstream and concentrates the contaminants between the filaments. The coating 43 may, for example, be a material that releases the particulate contaminant accumulated thereon for assaying or other investigative purposes after treatment with an appropriate reagent, or provide a colorimetric indication of the presence of a particular airborne contaminant in contact therewith either with or without treatment by suitable indicator reagents.

The above-described embodiment is shown in FIG. 5 wherein the airborne contaminant indicating device 10 is seen to be comfortably positioned within the (partially sectioned) nose 40 of the patient. The surfaces 13 and 13′ elastically urge outward to press laterally outward against the wall of the nasal passage and provide a smooth, non-irritating tissue-contacting surface for comfort. The anterior projection 12′ of the dilating portion is shown facing the front or anterior portion 51 of the nose 40 and the septum attachment portion is releasably attached to the inferior margin 41 of the nasal septum by medially directed elastic restorative forces.

FIG. 6 is a perspective view of an embodiment of the airborne contaminant indicating device 10 including gripping pins 61 adapted to be grasped by an instrument 62 for facilitating instrument assisted insertion of the device 10 into the nose. The airborne contaminant interactive coating 43 is applied to a portion of the surface of the device 10 so as to contact air flowing through the nose. FIG. 7 shows the cooperative functional relationship between the insertion instrument 62 and device 10 prior to insertion of the device into the nose. The tines 14 and 14′ of the extension portion of the device are urged toward one another in the direction indicated by the broad arrows in FIG. 7 and the proximal end 15 inserted into the person's anterior nasal passages and advanced thereinto by means of the instrument 62. When the pressure exerted by the instrument 62 on the pins 61 is released, the tines of the extension portion bear against the lateral tissue surfaces of the medial nasal septum to stabilize the device while the proximal arcuate tissue-contacting surfaces of the dilating portion buttress a portion of the inner perimeter of the nasal passages, urging the tissue in contact therewith radially outward to create and maintain symmetrically disposed open nasal airways.

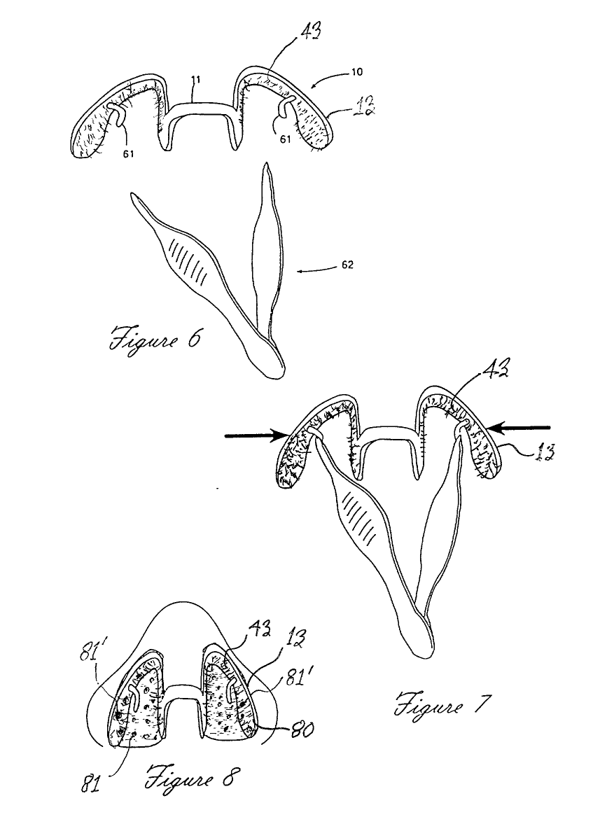

FIG. 8 is an elevational view looking upward into the nose 40 showing the airborne contaminant indicating device 10 properly positioned in accordance with this invention for maintaining an open airway within the nose, while presenting an interactive surface 43 to adsorb airborne contaminants 81 entrained in the air stream passing thereover. The airborne contaminant interactive coating 43, which may be a contaminant-specific adsorptive or reactive coating, may be affixed to the outer surface 80 (i.e., the surface in opposition to tissue contacting surface 13 and 13′) of the dilating portion of the airborne contaminant indicating device 10 to adsorb or chemically react with airborne contaminants 81 entrained in the air stream. FIG. 8 shows a portion 81′ of the airborne contaminants 81 trapped in a lattice provided by a cilia-like coating 43. In addition to the present invention's utility for maintaining an airway and indicating exposure to an airborne contaminant, the tissue-contacting surfaces 13 and 13′ of the device may be open cell or porous and permeated with a medicament that is released into the tissue in contact therewith.

A preferred method for providing a contaminant indicating coating 43 comprises the application of a thin film of an adsorbant or chemically reactive reagent or a hydrogel or silicone gel coating containing an indicator reagent that provides, or can be further treated to provide, an indication of exposure to an airborne contaminant to the surface 80 of the airborne contaminant indicating device 10 to form coating 43 thereon. After use, the coated surface 43 of the device can be either visually inspected to indicate exposure to an airborne contaminant, or the coating may be further treated by a visualizing reagent as, for example, in a home test kit, to provide an indication of the exposure of the coated surface 43 to an airborne contaminant. In a particularly preferred embodiment, the coating 43 comprises a layer of synthetic polymer having fibrils or a tortuous surface projecting into the air stream. After use, at the end of a day, for example, the device 10 can be removed from the nose and treated by immersing the coating 43 in a solvent that will dissolve the fibrils and release the particulate contaminants, entrapped and accumulated therein, into the solvent. The solvent containing the contaminants in suspension can be mounted on a slide for microscopic examination, cultured, or otherwise analyzed for detection of the presence of, and the determination of the amount of, a contaminant, such as, for example, anthrax spores, that may be injurious to health. In addition, a test kit may be used in a home environment for providing a visual indication, such as a color change, of exposure of the coating 43 to an airborne contaminant. Appropriate medicaments such as, for example, antibiotics exhibiting a therapeutic effect may then be timely administered to the patient if a high level of exposure to a particular contaminant is indicated.

While particular embodiments of the present invention have been illustrated and described, it would be obvious to those skilled in the art that various other changes and modifications can be made without departing from the spirit and scope of the invention. For example, the airborne contaminant indicating device 10 is applicable, or may be adapted to concentrate and/or detect any number of different airborne contaminants, the particular contaminants detected depending on the specificity of the coating 43. Further, while a particular embodiment of an airway device that is suitable for supporting a contaminant sensitive or adsorbant coating within the nose and present the coating to the air stream passing through the nose, has been described, the particular device 10 is intended to provide a preferred exemplar of the invention. Many other possible geometries are possible for the airborne contaminant indicating device 10. For example, a single length of elastomeric tubing or a spring-loaded semi or hemi tube dimensioned to fit snugly within the nose and present a reactive surface to the air stream may be used to meet the objectives of the present invention. It is therefore intended to cover in the appended claims all such changes and modifications that are within the scope of this invention.

What I claim is:

1. An airborne contaminant indicating device adapted for attachment to a person's nose for indicating the presence of a contaminant entrained in an air stream passing through the nose, said airborne contaminant indicating device comprising a member dimensioned to fit snugly within a nose without substantially obstructing the flow of air through the nose, said member having a surface that is in contact with air passing through the nose, said surface being coated with a layer of material that interacts with a contaminant in the air such that the interaction may be used to selectively indicate the presence of a contaminant in the air.

2. An airborne contaminant indicating device adapted for attachment to a person's nose for indicating the presence of a contaminant entrained in an air stream passing through the nasal passage of the nose, said airborne contaminant indicating device comprising:
(a) a dilating portion comprising two substantially U-shaped strips of an elastically deformable biocompatible material, said substantially U-shaped strips lying substantially in a first plane and being mirror images of one another and having a substantially uniform width and a smooth outer, tissue-contacting surface and an inner air-contacting surface in opposition thereto; and
(b) an extension portion integral with said dilating portion comprising two straight strips of said elastically deformable biocompatible material having a length and said substantially uniform width, each of said two straight strips having a proximal end integral with one of the two U-shaped strips, a distal end, and an outer septum-contacting surface which is coplanar with at least a portion of said tissue-contacting surface of said U-shaped strip integral therewith; and
(c) a septum attachment portion comprising a substantially arcuate strip of said elastically deformable material having said substantially uniform width, said substantially arcuate strip having two parallel straight edges, each straight edge being integral with a distal end of one of said straight strips comprising the extension portion wherein said two straight strips and said arcuate strip lie in a second plane which is orthogonal to said first plane; and
(d) a contaminant interactive coating on said outer surface of said dilating portion, said contaminant interactive coating being operable for interacting with airborne contaminants in contact therewith, the interaction providing a qualitative or quantitative indication of the presence of said contaminant in air passing thereover.

3. A kit for use with a airborne contaminant indicating device in accordance with claim 1 comprising visualization means operable for indicating exposure of said contaminant interactive coating to an airborne contaminant.

4. A kit for use with a airborne contaminant indicating device in accordance with claim 2 comprising visualization means operable for indicating exposure of said contaminant interactive coating to an airborne contaminant.
